(19) United States
(12) Patent Application Publication
(10) Pub. No.: US 2001/0017612 A1
(43) Pub. Date: Aug. 30, 2001

(54) Method of displaying images on a matrix display device

(76) Inventors: Antonius Hendricus Maria Holtslag, Eindhoven (NL); Jurgen Jean Louis Hoppenbrouwers, Eindhoven (NL)

Correspondence Address: Corporate Patent Counsel, U.S. Philips Corporation, 580 White Plains Road, Tarrytown, NY, 10591, US

(21) Appl. No.: 09/772,477

(22) Filed: Jan. 29, 2001

(30) Foreign Application Priority Data
Feb. 1, 2000 (EP) 00200330.9

(51) Int. Cl. G09G 3/36

(52) U.S. Cl. 345/103; 345/63

(57) ABSTRACT

A method of displaying successive image frames on a matrix display device, where said device comprises a set of lines, and luminance value data are coded in subfields, e.g. plasma display panels (PDPs), plasma-addressed liquid crystal panels (PALCs), liquid crystal displays (LCDs), Polymer LED (PolyLEDs), Electroluminescent (EL) used for personal computers, television sets, etc.

In order to reduce the address period, or addressing time without impairing image definition and without creating motion artefacts, grouping of adjacent lines in sets of lines is performed differently for each successive frame and for different regions of the display device, e.g. lines may be grouped by three in the upper half of the display, and by two in the lower one, in odd frames, and reversely in even frames. A common luminance value data for one or more subfields is addressed simultaneously to all lines of a set of lines.

### FIELD OF THE INVENTION

The invention relates to a method of displaying images on a subfield driven matrix display device.

The invention is applicable, inter alia, to plasma display panels (PDPs), plasma-addressed liquid crystal panels (PALCs), liquid crystal displays (LCDs), Polymer LED (PolyLEDs), Electroluminescent (EL) used for personal computers, television sets, etc.

### BACKGROUND OF THE INVENTION

As shown in FIG. 1, a matrix display panel such as a plasma display panel comprises a set of data electrodes usually extending in the column direction and a set of scanning electrodes usually extending in the row direction.

One method of displaying luminance levels in such a plasma display panel is known from EP 0 890 941. In this method, a field, as shown in FIG. 2 comprises, say, 8 subfields (in practice, 6 up to 12 subfields are used). Each subfield may comprise an erase period for conditioning the panel, an address period for priming the cells that should be lit during sustaining, and a sustain period during which the actual light is generated. The sustain period of each subfield is given, for example, a weight of 128, 64, 32, 16, 8, 4, 2, or 1 corresponding to an 8-bit digital signal (b7,b6,b5,b4,b3,b2,bl) and allowing to obtain 256 luminance levels. The total sustain period for one field should be as long as possible in order to obtain a high brightness.

The erase period is rather short, say, 0.2 ms , i.e. 8×0.2 ms=1.6 ms per field. The address period is about 3 μs per line. For a VGA display, comprising 480 display lines, the address period per subfield equals 480×3 μs=1.5 ms. At 8 subfields per field, the total address period is therefore 12 ms. At a field rate of 60 Hz (period 16.6 ms), only 3 ms is left as the total sustain period per field.

The reduction of the address period is one of the main challenges in the design of a plasma display panel.

Methods have been developed for reducing the address period, thereby increasing the sustain period.

Two methods of reducing the address period are disclosed in EP-A-0 890 941. In these methods, the high-weight subfields b8,b7,b6,b5 are addressed for each display line, and the low-weight subfields b4,b3,b2,b1 are addressed for only part of the display lines.

In the first of these methods, the odd low-weight subfields b3,b1 are addressed to odd-numbered scanning lines and the even low-weight subfields b4,b2 are addressed to even-numbered scanning lines.

In the second of these methods, two adjacent scanning electrodes are addressed simultaneously with the same data (quasi-whole scanning).

Both of these methods allow a reduction of the address period by a factor of two for doubled subfields, or of the total address period by 25%, thereby allowing a substantial increase of the duration of the sustain period.

These methods improve the brightness of the video signal displayed, but at the expense of a loss of quality in comparison with the original signal. A loss of resolution and/or of sharpness is induced by the omission of half of the lines in the first method, and by the duplication of the lines in the second method. Moreover, the average brightness of the image displayed may not correspond to that of the original image.

### SUMMARY OF THE INVENTION

It is an object of the invention to provide a method of displaying successive image frames or fields on a matrix display device of which more than one line is simultaneously addressed to increase the brightness through a reduction of the address period, in which there is less loss of resolution and/or fewer motion artefacts are introduced in moving pictures.

The invention provides a method of displaying successive image fields on a matrix display device as defined in claim 1. According the invention, sets of adjacent lines (i.e. 2, 3 or more lines) are formed, and the same luminance value for some of the least significant subfields is displayed. By addressing more lines simultaneously, the address period is reduced, thereby leaving more time for the sustain period. The value displayed may be the average value of the original individual values. By grouping the lines differently in successive frames and/or different areas of the display, further reduction of the address period is obtained, without loss of resolution.

More specific aspects of the invention are set out in the dependent claims.

These and other aspects of the invention are apparent from and will be elucidated with reference to the embodiment(s) described hereinafter with reference to the accompanying drawings.

### BRIEF DESCRIPTION OF THE DRAWINGS

In the drawings:

FIG. 1 schematically illustrates a prior art method (single line addressing);

FIG. 2 shows a subfield distribution, and the time gain obtained by double line addressing of the three least significant subfields;

FIG. 3 schematically illustrates a method in which double line addressing is used;

FIG. 4 schematically illustrates a method according to the invention, in which double line and double frame addressing are used;

FIG. 5 schematically illustrates methods according to the invention in which different multiple line and multiple frame addressing are used;

FIG. 6 schematically illustrates methods according to the invention in various combinations;

FIG. 7 schematically illustrates a method according to the invention in which double surface addressing is used, and

FIG. 8 shows a block diagram of a display apparatus according to an embodiment of the invention.

### DETAILED DESCRIPTION OF THE PREFERRED EMBODIMENT

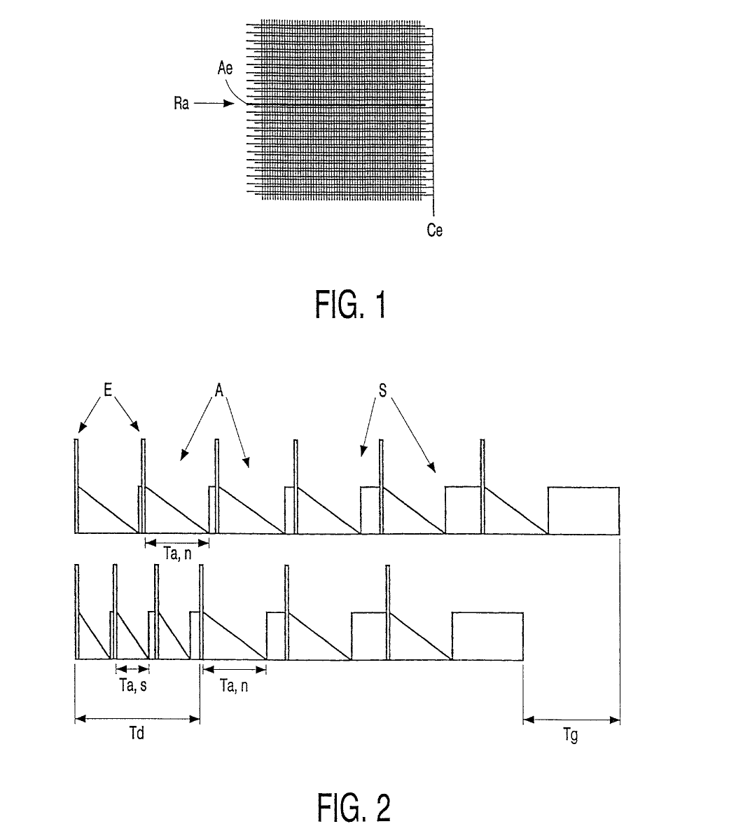

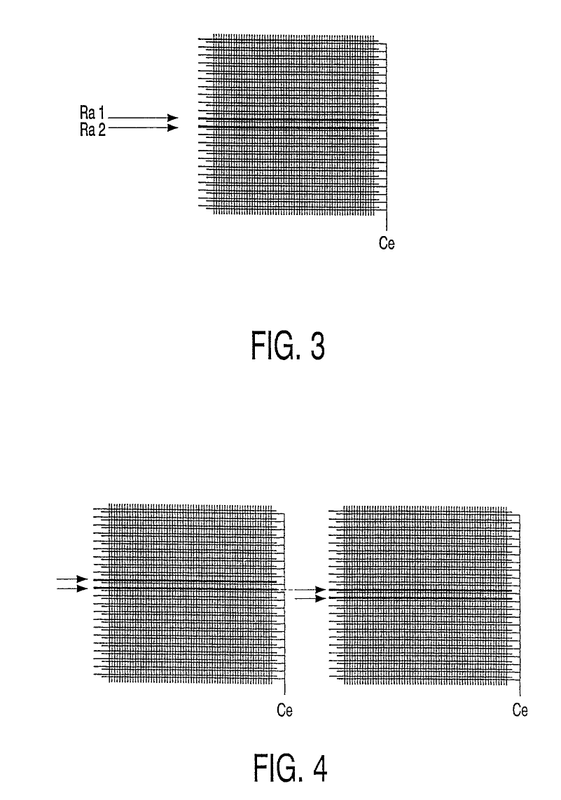

FIG. 1 shows a display panel known in the art, where each row is addressed individually. Two electrodes are associated with each row; an address electrode Ae and a common electrode Ce. The arrow indicates the addressed row Ra. This leads to the timing diagram of a field shown in the upper half of FIG. 2, where the address period, or addressing time, Ta,n is the same for each subfield. It is well known that the address time Ta,n may be reduced by the so-called line-doubling method, applied to some of the least significant subfields, and this is shown in the lower half of FIG. 2. FIG. 3 shows how two adjacent rows Ra₁ and Ra₂ are addressed at the same time, with the same data. The address time Ta,s is thereby reduced, leaving more time for the sustain period S. The high bars referred to as E represent the erase periods. The triangles referred to as A represent the address periods, and the rectangles referred to as S represent the sustain periods. The line doubling which occurs during the period Td causes a time gain Tg which can be used to increase the duration of the sustain period S.

The inventors have observed that a further improvement is obtained by combining and mixing several features.

A first improvement is obtained by grouping the lines in different sets of lines for different subfields.

FIG. 4 shows an example where lines are grouped in line pairs for odd fields, and in other pairs of lines, shifted by one line, for even fields.

A second improvement is obtained by displaying the average value of the original luminance value data of the set of lines, instead of a copy of one of the original lines to the other lines in the set, as is known in prior art document EP 0 890 941 for double line addressing.

A further improvement is obtained by grouping the lines differently in successive fields of frames.

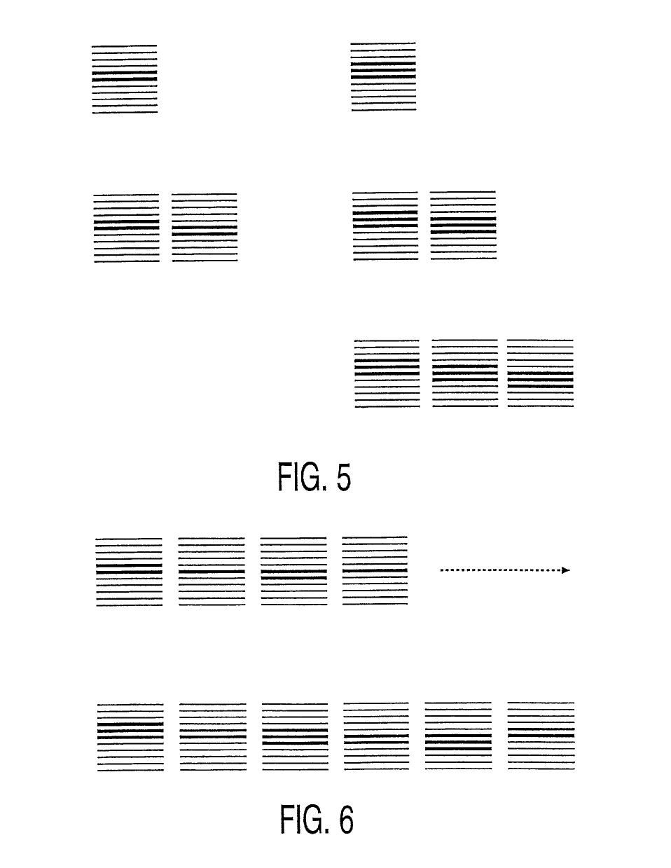

FIG. 5 shows, (upper left example) how, for all frames and all subfields, the lines are grouped in pairs (double line, single frame addressing). In the second example on the left, lines are grouped in pairs of lines in odd frames, and in shifted pairs of lines in even frames (double line, dual frame addressing). In the third example (upper right example), lines are grouped in sets of three lines for all frames and some subfield(s) (triple line, single frame addressing). The addressing time for said subfield(s), is thereby reduced to one third. In the fourth example (middle right example), lines are grouped in sets of three lines in odd frames, and in other sets of three lines, shifted by one line, for even frames (triple line, dual frame addressing). The last example of FIG. 5 (lower right example) shows triple line, triple frame addressing. The sets of three lines are shifted by one line for each successive frame.

A wide range of combinations may be realised within the framework of the invention. FIG. 6 shows further examples of valid combinations. In the upper example of FIG. 6, double line addressing is used in odd frames or in the odd fields, and single line addressing is used in even frames or in the even fields. In the lower example of FIG. 6, triple line, triple frame addressing is interspersed with double line, double frame addressing.

The above methods may be applied differently for each subfield. The loss of definition resulting from triple line addressing may be acceptable if using triple (or higher-multiple) line addressing for the lowest least significant subfields, and double line addressing for the higher least significant subfields.

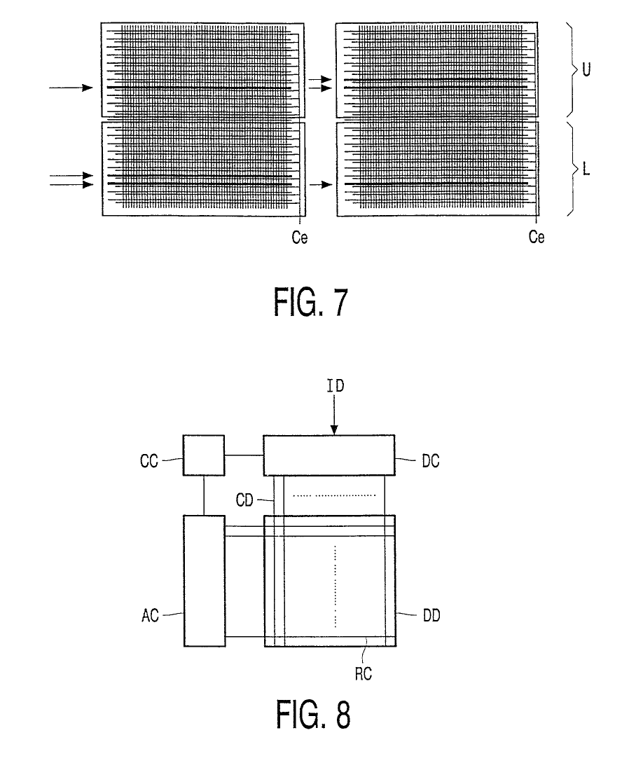

The above methods can also be applied differently for different regions of the display (multiple surface addressing). FIG. 7 shows an example of a display device that is independently addressable in the upper and the lower half regions (U and L). In this example, one method is applied for the upper half region, and another method is applied for the lower half region, for one frame or field, and the methods are reversed for the next successive frame or field.

Although all examples above show deterministic sequences and combinations, random sequences of multiple line, multiple frame, multiple surface for randomly selected subfield combinations may be used. A subset of allowed address methods is established, and a random selection within that subset is performed.

FIG. 8 shows a block diagram of a display apparatus according to an embodiment of the invention.

A subfield driven matrix display device DD has row conductors RC selected by an addressing circuit AC. A data supplying circuit DC receives image data ID to supply data to column conductors CD. A control circuit CC controls the addressing circuit AC and the data supplying circuit DC.

For example, during the addres period A of a predetermined subfield, the control circuit CC instructs the addressing circuit AC to address (select) two adjacent row conductors and instructs the data supplying circuit to supply the same data to the selected row conductors to prime two rows with the same data.

During the sustain period, the control circuit CC instructs the addressing circuit AC to supply a number of sustain pulses to the row conductors corresponding to the weight of the subfield.

While the invention has been described in connection with preferred embodiments, it will be understood that modifications thereof within the principles outlined above will be evident to those skilled in the art, and thus the invention is not limited to the preferred embodiments but is intended to encompass such modifications.

1. A method of displaying successive image frames or fields on a subfield driven matrix display device comprising display lines being addressed in sets of adjacent lines, said image frames or fields having original luminance value data being coded in subfields comprising a group of most significant subfields and a group of least significant subfields, a common luminance value data being supplied to lines of a set of said sets of lines, characterized in that said addressing in sets of adjacent lines is performed differently for (i) successive frames or fields and/or (ii) for different regions of the display device and/or (iii) for different subfields.

2. A method as claimed in claim 1, characterized in that said common luminance value data for said at least one of the least significant subfields is obtained by averaging the corresponding least significant subfield original luminance value data of said set of lines.

3. A method as claimed in claim 1, characterized in that said sets of lines comprise sets of two lines.

4. A method as claimed in claim 1, characterized in that said sets of lines comprise sets of three lines.

5. A method as claimed in claim 1, characterized in that said sets of adjacent lines comprise sets of lines having the same number of lines, said sets being shifted by one or more lines in each successive frame.

6. A method as claimed in claim 1, characterized in that said display device comprises a first region being the upper half of the display and a second region being the lower half of the display.

7. A method as claimed in claim 1, characterized in that said grouping of lines for each successive frame or field and for different regions of the display device is performed in a random manner.

8. A display apparatus comprising a subfield driven display device for displaying successive image frames or fields on display lines, said image frames or fields having original luminance value data being coded in subfields comprising a group of most significant subfields and a group of least significant subfields, the display apparatus further comprising means for addressing the display device in sets of adjacent lines, and means for supplying a common luminance value data to lines of a set of said set of lines, characterized in that the display apparatus comprises means for selecting different sets of adjacent lines for:
(i) successive frames or fields, and/or
(ii) for different regions of the display device, and/or
(iii) for different subfields.
